(19) United States
(12) Patent Application Publication
(10) Pub. No.: US 2009/0107069 A1
(43) Pub. Date: Apr. 30, 2009

(54) Method for the Production of the End-Products for Civil and Urban Building and End-Products Thus Obtained

(75) Inventor: Marco Enrico Cora', Valdagno-Vicenza (IT)

Correspondence Address: HEDMAN & COSTIGAN P.C., 1185 AVENUE OF THE AMERICAS, NEW YORK, NY, 10036, US

(73) Assignee: RI.C.R.A.E.E. S.r.l., SCHIO (VI) (IT)

(21) Appl. No.: 12/225,633

(22) PCT Filed: Mar. 28, 2007
(86) PCT No.: PCT/IB2007/000900

§ 371 Date: Sep. 25, 2008

(30) Foreign Application Priority Data
Mar. 30, 2006 (IT) VI2006A000088
Jul. 24, 2006 (IT) VI2006A000234

(51) Int. Cl. B32B 3/10; B32B 17/06; E04F 13/00; B29C 59/02

(52) U.S. Cl. 52/311.1; 428/174; 264/114

(57) ABSTRACT

A method for the production of end-products for civil and urban building whereby one or more layers of glass-based materials, compounds from crystal fragments joined to each other by means of resinous chemical binders are used, which can be subsequently coupled with at least one reflecting or transparent panel; a series of end-products are thus produced for civil and urban building, such as coating panels, ornament objects and fittings in general, having a strong visual, luminous and decorative impact. When end-products for false-ceilings are used, at least one layer of plastic material, of the type comprising air cushions, such as, for example, so-called “bubble” material, is coupled with the layers of glass-based material in order to lighten the structure.

The present invention relates to a method for the production of end-products for civil and urban building and a series of end-products, thus obtained, which can be used for civil and urban building, which are easy to use.

The end-products are mainly produced with layers consisting of fragments or granules, in particular of crystal, having various forms and dimensions, joined to each other, inside certain moulds, by means of resinous chemical binders, and are characterized in that they have an extremely light structure and ornamental impact with a rare aesthetical effect.

In particular, the fragments or granules, reduced to suitable forms and dimensions are obtained by means of adequate crushing, reclaiming and smoothing processing of the crystal of kinescopes, which, in this way, can be re-used and recycled, whereas the end-products, obtained economically and rapidly, by forming a paste in which these granules are bound by means of resins, can be used for civil and/or urban fittings i.e. for purely ornamental purposes, such as small common objects.

Panels, also shaped, suitable for being positioned in mural structures or for use as table surfaces, as well as diffusion screens of lamps or similar products, can be produced starting from these compounds, containing crystal or resin granules as binding element, by simply coupling at least one reflecting or transparent panel.

If the end-products are used as mural panels or panels for false ceilings and are therefore important for lightening the whole structure, it is also possible to couple the layers of glassy material, with or without reflecting or transparent panels, with one or more layers or films of light plastic material containing air (or with air bubbles, such as so-called “bubble” material), possibly curved and/or suitably shaped.

Reflecting or transparent panels which can be used, either flanked or alternating, are layers of silver paper and/or specific light panels made of ferrous or non-ferrous material, having various forms and dimensions; for obtaining a better visual effect, on the other hand, certain colouring substances can be added to the resinous chemical binder, or the panels themselves can be coloured or decorated with specific colours and inks.

As already mentioned, the fragments or granules, reduced to suitable forms and dimensions, can be advantageously obtained from glass material in general or by means of adequate crushing, reclaiming and smoothing processing of crystal coming from waste products (such as kinescopes of televisions or computer screens) which can therefore be re-used and recycled as raw material, whereas the end-products, obtained economically and rapidly, by forming a paste in which these granules are bound by means of resins, can be used for civil and/or urban fittings or for strictly ornamental purposes, such as small objects and fittings in general.

Problems relating to the disposal and recycling of glass material in general and of the crystal of kinescopes in particular, are known; the difficulties encountered during separation operations of glass material and crystal from other materials, in particular for materials which are difficult to treat (such as cathode tubes of kinescopes) are also known, both from a technical and environmental point of view, in order to obtain total re-use of the glass material, as well as the costly disposal operations to which these products must be subjected.

It would consequently be useful to envisage an alternative use of glass material and/or crystal, without having to dispose of it, in order to obtain a progressive and constant reduction of the non-recoverable waste fraction.

Furthermore, the coating panels and ornamental items in general produced with end-products made of a glass-based material normally have a heavy and cumbersome structure, which completely limit their utilization; this drawback should also be avoided.

An objective of the present invention is therefore to avoid the drawbacks mentioned above and, in particular, to indicate a method for producing end-products for civil and urban building which progressively reduces the non-recoverable waste fraction, to be sent for disposal, in order to create a product having a high environmental efficiency and which can be continually recycled.

Another objective of the invention is to indicate a method for the production of end-products for civil and urban building, which is extremely reliable and which allows an evident saving in recycling and disposal costs.

A further objective of the present invention is to provide important end-products for civil and urban building, obtained simply and economically and easy to use, which can be adopted as decorative items and/or for civil and urban fittings, such as coating portions, panels and/or flooring, in substitution of the inert materials currently used for these purposes.

Another objective of the present invention is to provide end-products for civil and urban building, which have a considerably light construction and/or structure, with excellent soundproofing and non-polluting properties and which can be used, for example, as coating panels, light diffusion screens, furnishing fittings and ornamental items in general.

Yet another objective of the invention is to provide a series of coating and/or ornamental end-products, having an important and rare aesthetical impact, obtained industrially simply and economically, which can be used as decorative elements and/or for civil and urban fittings, such as coating portions, panels, flooring and/or ceilings, in substitution of or as an alternative to or as a complement of current structures made of plasterboard and inert materials currently used for these purposes.

These and other objectives are achieved by producing end-products for civil and urban building according to claim 1 enclosed and embodying a method for the production of the above end-products according to claim 8 enclosed; other detailed characteristics of the method and end-products thus obtained are indicated in the subsequent claims.

Coating panels for walls, ceilings and tables, coatings for buildings, construction blocks, floor casts, marble-chip floor tiles, tiles and end-products, used as fitting accessories for civil and urban building, are normally produced using plasterboard and/or a grit of various stones, granites, marbles and common stones, finely crushed and joined by means of mortar and cement.

Many of these applications, moreover, do not require that the end-products have a considerable resistance to compression and/or tensile-stress, as a good wear resistance, a sufficient flame resistance and a pleasant and qualitatively valid appearance are sufficient.

During a series of experiments and research tests aimed at finding alternative utilizations for the use of plastic and/or glass material, the appreciable beauty and lightness of the structures obtained according to the invention, in addition to the light effects and shades and transparency that these structures, possibly treated with resins and/or specific colouring substances, produce, were advantageously and surprisingly noticed.

Further ornamental effects are produced by the same structures in contact with transparent or reflecting panels and/or with layers of coloured or silver paper and/or with other suitably coloured panels.

The present invention therefore proposes end-products obtained by smoothing fragments or granules of glass or crystal and glass-based material in general, mixing it with at least one chemical binding element, for example resin-based, with or without colouring substances, and subsequently introducing the paste obtained inside predetermined moulds; the reflecting or transparent panel or layers of silver or coloured paper can also be previously inserted inside the above moulds.

The end-product thus obtained can also be subsequently coupled with transparent or reflecting panels and/or layers of silver paper.

Ornamental items, coating panels and worktops, end-products for flooring, ceilings and fitting accessories and/or end-products for urban fittings and the building industry in general, are thus obtained.

In order to lighten the final product, the end-products can also be produced by interposing one or more layers of light plastic material containing air, such as so-called “bubble” material, inside the structure, suitable for creating an air cushion, possibly curved or appropriately shaped and possibly coupled with transparent or reflecting panels and/or layers of silver paper and/or specific panels, ferrous and non-ferrous, suitably coloured.

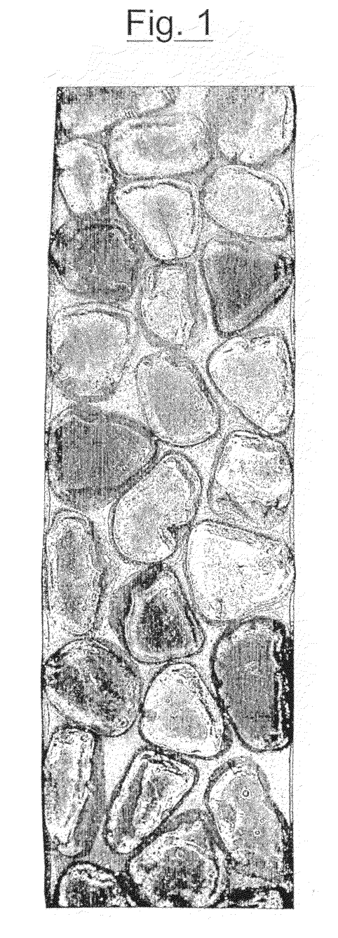

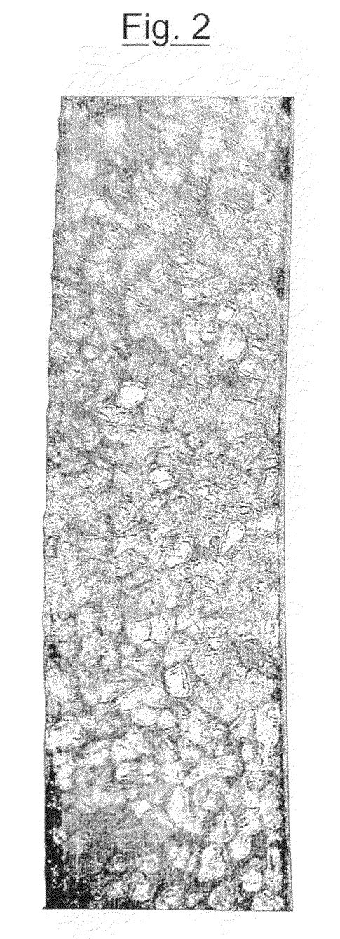

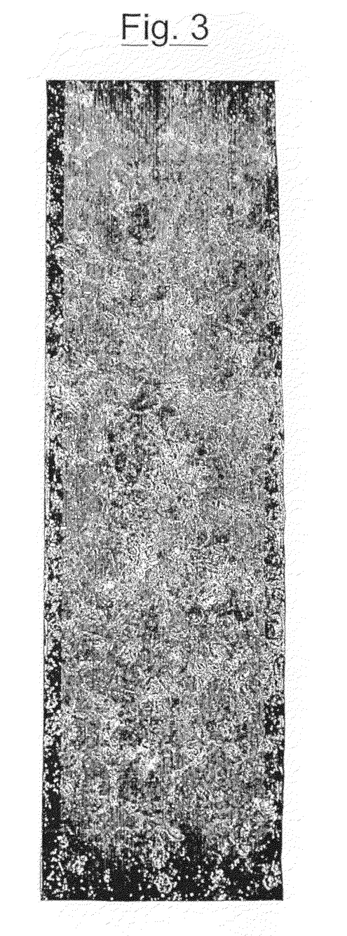

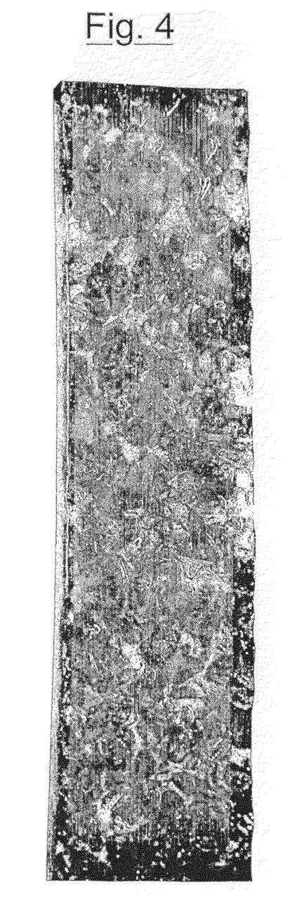

Further objectives and advantages of the present invention will appear evident from the following description relating to illustrative and preferred but non-limiting embodiment examples of the production method of end-products for civil and urban building and the end-products thus obtained, and from the enclosed FIGS. (FIGS. 1-6) which show portions of end-products differing in form and colouring, according to the invention.

The glass material and/or crystal, used according to the invention, derive from processing processes which can envisage manual or automated operations, also through the recovery of the raw material from relative semi-processed products, and the disposal of the remaining non-utilizable material.

In particular, according to preferred illustrative and non-limiting embodiments of the present invention, the crystal currently used mainly derives from the recovery of the glass of electronic equipment in disuse, such as old kinescopes, by suitably separating the iron which forms the outer framework of the screen of kinescopes, from the screen and glass of the cone.

This operation can be effected according to manual procedures, by means of a fixed circular saw and/or by means of a laser cutting operation, or by means of magnetic systems, and subsequently brushing the phosphorous powders (manually or with chemical substances), in order to obtain an optimum size of the components for their remelting, and/or effecting further fragmentation and sieving operations of the material removed and subdivided.

The process for the recovery of the crystal from kinescopes can also be effected with automatic or automated procedures, by means of specific machines, suitable for demolishing the kinescope, cleaning the glass from the particles of phosphorous and other heavy coating metals, collecting and transferring the crystal fragments and suction of the phosphorous powder.

According to the present invention, when the glass material has been collected, whatever procedure may have been used, the glass or crystal fragments or granules are automatically or manually transferred into one or more machines or drum tumblers, functioning with washing water or also dry, and rolled inside a basket or other containment element, rotating in a single direction or alternatively in one direction and then in the opposite direction, in order to also obtain the smoothing and partial rounding of the above fragments.

In particular, these fragments or granules of glass material can be positioned inside machines, such as washing machines and/or barrel or drum tumbler concrete mixers, whose basket-shaped containment element can also contain a suitable quantity of water (in which, in this case, the granules of glass material are immersed) and then roll in one direction and/or in the opposite direction.

In alternative embodiments, the granules can be transferred, either automatically or manually, into one or more cement mixers or containment barrels or drum tumblers, whose internal basket rotates in a single direction or in one direction and in the opposite direction, for pre-established times.

Each drum tumbler can also be maintained in depression and operated under dry conditions, in order to obtain suitably dimensioned, cleaned and smoothed granules of glass material.

In any case, the definitive form and cleaning of these granules is obtained by abrasion of the fragments of glass material which continue to roll inside the basket of the drum tumbler, in one direction and/or in the opposite direction, followed by a suction phase of the powders and other portions of material detached from each granule, due to the movement of the above basket.

Finally, the containment element of the granules (basket of the washing machine or drum tumbler) can be equipped with a series of holes, having suitable dimensions, suitable for discharging, during the movement, the powders and small pieces of crystal and/or coating metal inside and outside the cone of kinescopes, which are formed as a result of the continuous impact and abrasion of the granules between each other and against the walls of the basket of the washing machine or drum tumbler.

In this way, granules of glass material are obtained, having various forms and dimensions and different shades, which are suitably and specifically smoothed, rounded and/or beaten, following the treatment described above.

After discharging the powders, the granules are then removed, cleaned, selected and mixed with chemical binders, such as resins and/or specific catalysts and optionally with other colouring substances, obtaining a sufficiently fluid paste which, when immersed in certain moulds and after being left to harden, allows the production of ornamental objects, coating panels, table tops and furniture in general, light diffusion screens and fitting accessories in general, wall coatings, thresholds and end-products for fittings for civil and urban building in general, such as those illustrated in the enclosed FIGS. 1-6, which differ in the variety, form and colour of the crystal granules.

Once the catalyzation process of the resin has been completed, the end-products are extracted from the moulds; the above end-products, compact and resistant, have a substantially smooth lower surface, due to the accumulation of the fluid resin in the lower part of the mould, during the catalyzation, and the upper surface is rough, due to the presence of granules of glass material on the surface, or also smooth in the case of the total immersion of the granules (FIGS. 1-4).

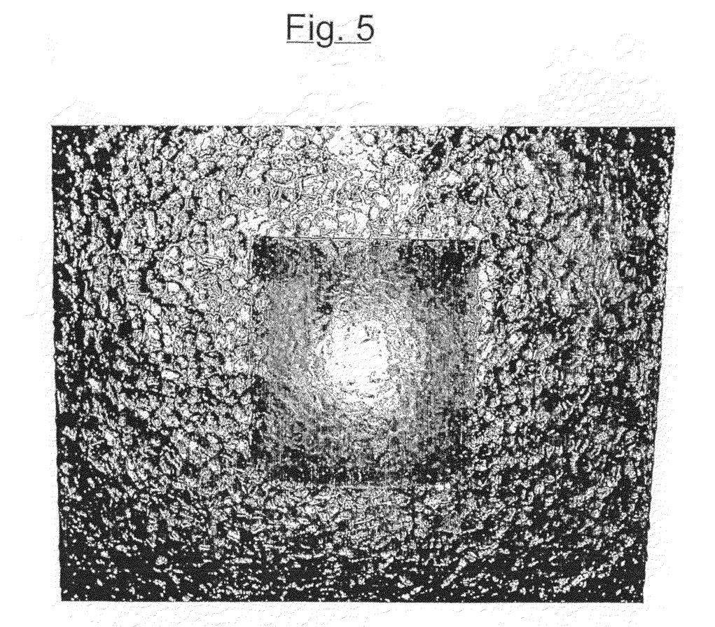

One or more transparent or reflecting panels and/or layers of silver paper and/or layers of plastic material containing air, such as so-called “bubble” material, possibly curved or suitably shaped, can also be coupled with the layers of glass material thus obtained, during the catalyzation phase of the resin, in order to guarantee an ideal aesthetic effect, at the same time giving the structure a particular luminosity and effectiveness having a rare aesthetic impact, due to the combination of reflections between the facets of the crystal, the various chromatic shades of the crystal selected, and the coupled reflecting panels (as in the embodiment example illustrated in FIG. 5 enclosed).

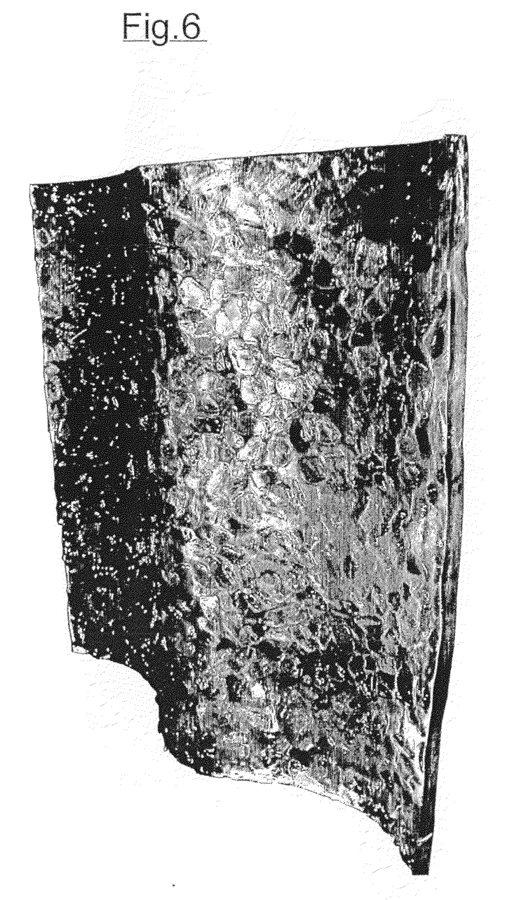

Decorative elements, ornamental objects and fitting accessories in general, thresholds, end-products for fittings for civil and urban building, coating panels of walls and ceilings (as in the embodiment example of FIG. 6) and furniture in general, in addition to light diffusion screens (as in the embodiment example of FIG. 5), are obtained in particular, which differ in the variety and form of the granules of glass material and different colourings.

The end-products can also be perforated, in certain areas, to allow them to be hooked to generic supporting structures and for their rapid and non-destructive substitution.

The characteristics of the method for the production of end-products for civil and urban building and the end-products thus obtained, object of the present invention, appear evident from the above description, as also the advantages.

Finally, numerous other variants can obviously be applied to the production method of end-products for civil and urban building in question, all included in the novelty principles inherent in the inventive idea. It is also evident that, in the practical embodiment of the invention, the materials, forms and dimensions of the details illustrated can vary according to requirements and can be substituted with other equivalents.

1. End-products for civil and urban building, easy to be used for ornamental purposes and/or for coatings in general, such as for example shaped coating panels, furniture tops, light diffusion screens, as well as fitting accessories and ornamental and/or structural objects in general, comprising a structure having one or more first layers of shaped and/or curved glass-based material, wherein each of said first layers consists of glass or crystal granules or fragments with smooth surfaces, said glass or crystal granules or fragments being immersed in a chemical binding element and being joined to each other by said chemical binding element and wherein at least one second layer, made of reflecting and/or transparent material, is coupled with said one or more first layers of shaped and/or curved glass-based material.

2. End-products according to claim 1, characterised in that said one or more first layers of shaped and/or curved glass-based material are coupled with coloured layers made of reflecting or transparent material.

3. End-products according to claim 1, characterised in that said one or more first layers of shaped and/or curved glass-based material are also coupled with at least one layer of plastic material, preferably of the type comprising air cushions, such as a so-called “bubble material”.

4. End-products according to claim 1, characterised in that said at least one second layer, made of reflecting and/or transparent material, consists of a layer of reflecting silver paper.

5. End-products according to claim 1, characterised in that said chemical binding element comprises resins.

6. End-products according to claim 1, characterised in that said glass granules or fragments consist of crystal pieces coming from the demolition of kinescopes.

7. The end-products according to claim 1, characterised in that they are perforated in certain areas for hooking to walls or supporting elements and for their rapid and non-destructive substitution.

8. Method for the production of end-products for civil and urban building according to claim 1, of the type comprising at least one demolition phase of the glass-based material, with the removal of the powders and small waste fragments of material, said glass-based material being thus reduced to fragments or granules having various forms and dimensions, wherein it comprises, after said demolition phase of the material, the following further phases:
at least one transferring and depositing phase of said fragments or granules to at least one rotating containment element;
at least one moving phase of said rotating containment element, in order to suitably smooth and clean said fragments or granules;
at least one selection and sieving phase of the smoothed and cleaned fragments or granules;
at least one mixing phase of at least one chemical binding element with said fragments or granules;
characterised in that the following further phases are provided:
mixing said chemical binding element with said fragments or granules;
casting the mixture comprising said chemical binding element and said fragments or granules inside at least one mould;
catalyzing said mixture;
extracting from the mould the product obtained;
coupling said product with said at least one second layer made of reflecting and/or transparent material.
moulding and colouring said at least one second layer made of reflecting or transparent material.

9. Method according to claim 8, characterised in that at least one colouring substance is added to said chemical binding element.

10. Method according to claim 8, characterised in that said rotating containment element is housed in a washing machine, in which washing liquid flows at a pre-established temperature.

11. Method according to claim 8, characterised in that said rotating containment element is housed inside a drum tumbler, suitable for operating under dry conditions and/or in depression, so as to smooth said fragments or granules by abrasion and to collect the powders and polluting substances separately with respect to the glass-based material.

12. Method according to claim 8, characterised in that said rotating containment element rotates in one direction.

13. Method according to claim 8, characterized in that said rotating containment element rotates alternatively and for prefixed time intervals, in one direction and in the opposite direction.
